(19) United States
(12) Patent Application Publication
(10) Pub. No.: US 2011/0179499 A1
(43) Pub. Date: Jul. 21, 2011

(54) System and Method for Communicating with Elected Officials

(76) Inventor: Richard H. Glanton, Princeton, NJ (US)

(21) Appl. No.: 13/009,642

(22) Filed: Jan. 19, 2011

Related U.S. Application Data
(60) Provisional application No. 61/296,070, filed on Jan. 19, 2010.
(60) Provisional application No. 61/354,870, filed on Jun. 15, 2010.

(51) Int. Cl. G06F 21/24

(52) U.S. Cl. 726/28

(57) ABSTRACT

A method for facilitating communication concerning elected officials or candidates for election is disclosed. A server stores information associated with elected officials or candidates for election. The information defines a constituency group for each elected official and for each candidate for election. A user is qualified for constituency groups when the user accesses the server through a computing device. The server then provides the user access to the information associated with those elected officials and candidates for election for which the user is a qualified member of the respective constituency group.

### PRIORITY

Priority is claimed under 35 U.S.C. §119 to U.S. Patent Application Ser. No. 61/296,070 filed Jan. 19, 2010; and U.S. Patent Application Ser. No. 61/354,870 filed Jun. 15, 2010; both entitled “SYSTEM AND METHOD FOR COMMUNICATING WITH ELECTED OFFICIALS”. The disclosures of the aforementioned priority documents are incorporated herein by reference in their entirety.

### FIELD OF THE INVENTION

The present invention generally relates to an information service for providing information about elected officials.

### SUMMARY OF THE INVENTION

Certain embodiments of the present invention provide for a system and method for communicating with and/or about elected officials by providing information regarding elected officials, such as information which falls within the purview of elected officials' responsibility and duties and information related to their offices and service in such offices.

Certain embodiments of the present invention relate to establishing a comprehensive mode of facilitating online communications to, from, about, between or among Internet users/members concerning “elected officials” and/or candidates for election via a website, such as a website that can be referred to as Elected Face, by way of non-limiting example. Elected Face may enable online users/members who reside in the political areas where elected officials serve, to post comments concerning political matters on pages applicable to affected elected officials via the website. Elected officials may elect to monitor such postings and opt to respond or do nothing. Online users/members may comment concerning postings which appear on any page of the website of Elected Face. Postings on pages of elected officials may appear as local or national postings as described below. According to certain embodiments of the present invention, Elected Face members/online Internet users who live outside the political entity or district of the affected elected official may be enabled to post comments on the page of the elected official only in space provided for national postings. According to certain embodiments of the present invention, only online Internet users/members who reside in the political entity represented by elected officials may be enabled to post comments on the local pages of the affected local official.

According to certain embodiments of the present invention, Elected Face members/online users may communicate with affected elected officials as noted above via text, photo, video and/or audio communications, such as to post videos relating to elected officials on their pages on the website of Elected Face.

The pages of elected officials may contain basic biographical information including employment history, religious and political affiliations, and/or any other available information concerning elected officials and/or their special interests.

According to certain embodiments of the present invention, the name of office held, term of years and certain political information concerning the status of the elected official may be provided on the page of each elected official identified on the website, with a stream of updates, for example.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and in which:

FIG. 1 illustrates a block diagrammatic representation of a system according to an embodiment of the present invention.

FIG. 2 illustrates a browser embodiment of the present invention; and,

FIGS. 3-20 illustrate graphical user interfaces according to embodiments of the present invention.

### DETAILED DESCRIPTION OF THE PREFERRED EMBODIMENTS OF THE PRESENT INVENTION

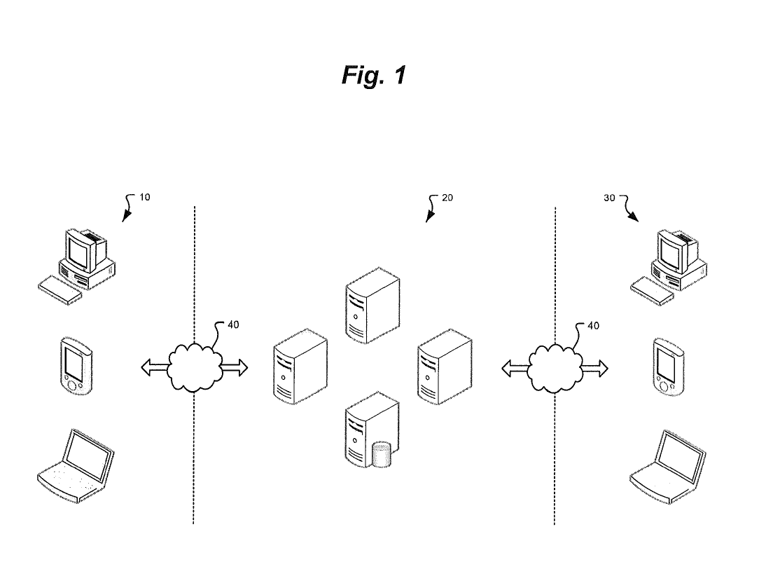

Referring now to FIG. 1, there is shown a configuration of a system according to an embodiment of the present invention. In certain embodiments of the present invention, such a system is well-suited for performing and/or providing functionalities described herein.

In the illustrated embodiment, the system generally includes a first class of computing devices 10, a second class of computing devices 20 and a third class of computing devices 30. In certain embodiments of the present invention, the groups need not be mutually exclusive. For example, one or more certain computing devices may be members of more that one of classes 10, 20 and/or 30. Generally, each of the computing devices of classes 10, 20 and 30 are communicatively interconnected with one another via at least one network, such as the Internet and/or wireline and wireless communications networks. In the illustrated embodiment of FIG. 1, the computing devices of classes 10, 30 are interconnected with the computing devices of class 20 via network connections 40. In certain embodiments of the present invention, one or more of the computing device interconnections, such as connections 40 by way of non-limiting example, may take the form of Internet or other data network connections.

In certain embodiments of the present invention, class 10 and 30 computing devices may generally take the form of end-user computing devices, such as personal computers, terminals, Internet enabled appliances or video game consoles, such as the Sony PlayStation3, personal digital assistants and/or cellular telephones or smart phones, for example.

In certain embodiments of the present invention, class 20 computing devices may generally take the form of servers, for example. In certain embodiments of the present invention, class 20 computing devices may correspond to network or system servers, such as website and/or database servers, for example.

In certain embodiments of the present invention, computing devices in class 20 provide a website that is accessible by computing devices in classes 10, 30, for example. By way of non-limiting example, providing such a website may generally include providing database services, and providing populated website pages using the database services.

By way of non-limiting explanation, “computing device”, as used herein, refers to a general purpose computing device that includes a processor, such as a device that possesses general purpose computing capabilities. A processor generally includes a Central Processing Unit (CPU), such as a microprocessor. A CPU generally includes an arithmetic logic unit (ALU), which performs arithmetic and logical operations, and a control unit, which extracts instructions (e.g., code) from a computer readable medium, such as a memory, and decodes and executes them, calling on the ALU when necessary. “Memory”, as used herein, generally refers to one or more devices or media capable of storing data, such as in the form of chips or drives. For example, memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may take the form of magnetic or optical—technology based storage media. Memory may be internal or external to a computing device. Memory may store a computer program, e.g., code or a sequence of instructions being operable by the processor. In certain embodiments of the present invention, one or more elements may take the form, or functionalities discussed may be provided using code being executed using one or more computing devices, such as in the form of computer device executable programs or applications being stored in memory. There are various types of computing devices, having varying processing and memory capabilities, such as: personal computers (like those that are commercially available from Dell and Apple Corp.), and personal digital assistants and smart phones (like those that are commercially available from Apple Corp., Motorola and Research in Motion), by way of non-limiting example only.

A “server”, as used herein, is generally communicatively coupled to a network, and manages network resources. A server may refer to a discrete computing device, or may refer to an application that is managing resources rather than an entire computing device. “Network”, as used herein, generally refers to a group of two or more computing devices communicatively connected to one-another. “Internet”, as used herein, generally refers to the global interconnection of computing devices, and computing device networks, commonly referred to as such.

“Website”, as used herein, generally refers to a collection of one or more electronic documents (e.g., webpages) that are available via a computer network, such as the global interconnection of computers and computer networks commonly referred to as the Internet. By way of non-limiting example, a website may be accessed at a given address on the World Wide Web (i.e., “www.URL.TLD”), and include a home page, which is the first webpage visitors typically see when they enter the site. A website may also contain additional webpages. Webpages may be fixed, and/or dynamically generated in response to website visitor webpage requests. By way of further non-limiting example only, the World Wide Web is a system of Internet servers that support HTML (Hypertext Markup Language), such that a website visitor can jump from one webpage to another webpage simply by clicking on references to other webpages, such as hot spots or hot links (sometimes referred to as “links”). Web browsing applications, such as Microsoft's Internet Explorer, Google's Chrome, and Apple's Safari are available applications used to access websites on the World Wide Web. Other computer network types and/or protocols and/or mark up languages and/or applications may be used. Webpages are typically served by servers.

In certain embodiments of the present invention, the system may include or provide a website to host information about elected officials and/or candidates for election. This information may include but is not limited to names, date of birth, education and professional background, and offices held in the United States and/or other countries. The website may be substantially continually updated, such as by having information change as offices held by office holders change. Such a functionality may be provided automatically, such as based upon automated queries or other accessing of public filings. Other methodologies may be used though, such as manual methods. The website may include functionality enabling citizens of an affected country, who becomes a member of the website, to post communications on political issues on the page(s) of the website corresponding to their elected officials with whom the citizen wishes to communicate with or about, for example.

In certain embodiments of the present invention, an online user may wish to access an embodiment of an inventive home web page through the website on the World Wide Web. A tool bar may list functions and categories under an appropriate heading which prompts users to access functions to be utilized. By way of non-limiting example, a heading may include a home page which designates an identifier and/or IP address of a system member or online user. A pop-up bar may appear which provides a list of options of elected officials on whose page a member or online user or others may post comments, starting with elected officials at local, state, and/or national levels.

According to certain embodiments of the present invention, members and/or users may have an option to post comments on a page corresponding to an elected official of their choice. A toolbar may enable members and/or online users to navigate to the page of any or every elected official, such as in the United States, to whom they wish to address comments to be posted. A toolbar may enable members and/or online users to navigate to the page of any or every elected official, such as in the United States, to whom they correspond, e.g., have a constituency. The tool bar may contain other sections. By way of non-limiting example, the toolbar may include a “favorites” section which may correspond to a primary listing of elected officials the user and/or member regularly communicates with through postings. By way of further non-limiting example, the toolbar may include a section comprising biographies of members and/or users comprising their respective background information. By way of further non-limiting example, the toolbar may include a section comprising an inbox for members or users to communicated directly with an elected official without posting for public access.

In certain embodiments of the present invention postings and/or petitions and/or virtual petition signatures from constituents of a given elected official may be distinguishable from postings and/or petitions and/or virtual petition signatures from non-constituents of a given elected official. For example, they may be visually distinguished by grouping, color and/or the ability to submit them, for example.

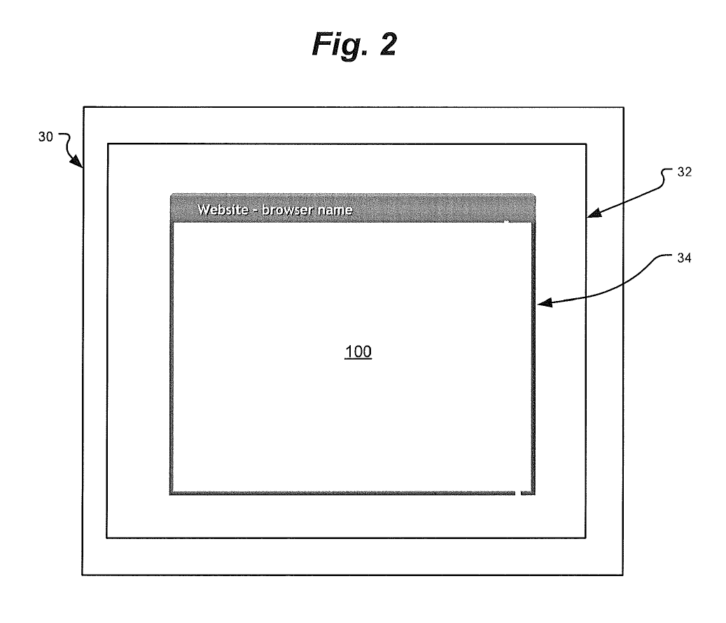

Referring now to FIG. 2, there is shown a block diagrammatic view of a portion of the system of FIG. 1 illustrating a provided website. In the illustrated embodiment, one or more of computing devices 30 include a display 32 presenting a website 100 via a browser application 34. Browser application 34 may be responsive to user interaction via the executing device 30 and/or computing devices 20 serving website 100 in a conventional manner.

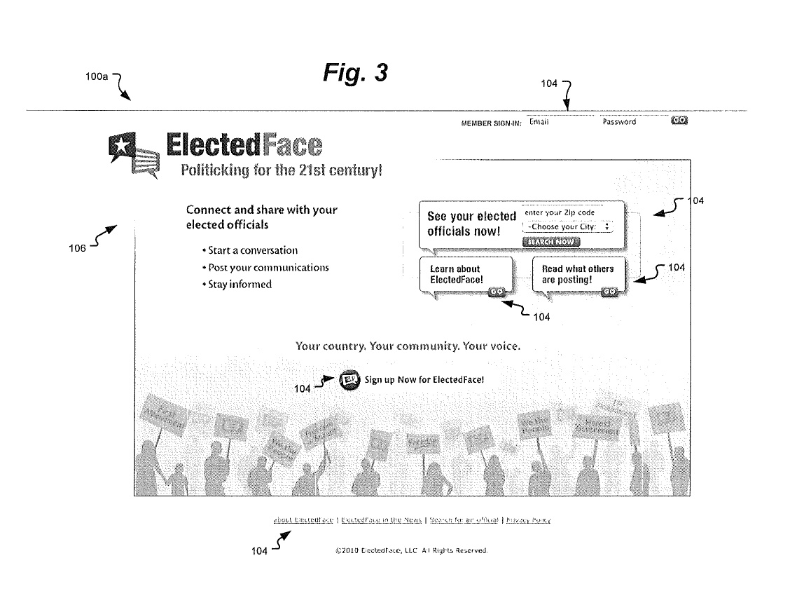

Referring now also to FIG. 3, an embodiment of a page 100a of website 100 is shown therein. Page 100a may be well-suited to serve as a homepage of website 100 in certain embodiments of the present invention. Page 100a may generally include navigation/data entry elements (e.g., links, textboxes, drop-lists . . . ) (hereinafter referred to as navigation elements) and/or content elements (e.g., graphic, text, video and/or sound components). In the illustrated embodiment, page 100a includes navigation elements 104 which allow users to: sign in if they are registered members; find their elected officials and/or candidates; learn about the website; read other users' posts; sign up to become a registered member, read press about the website and see policies related to the website.

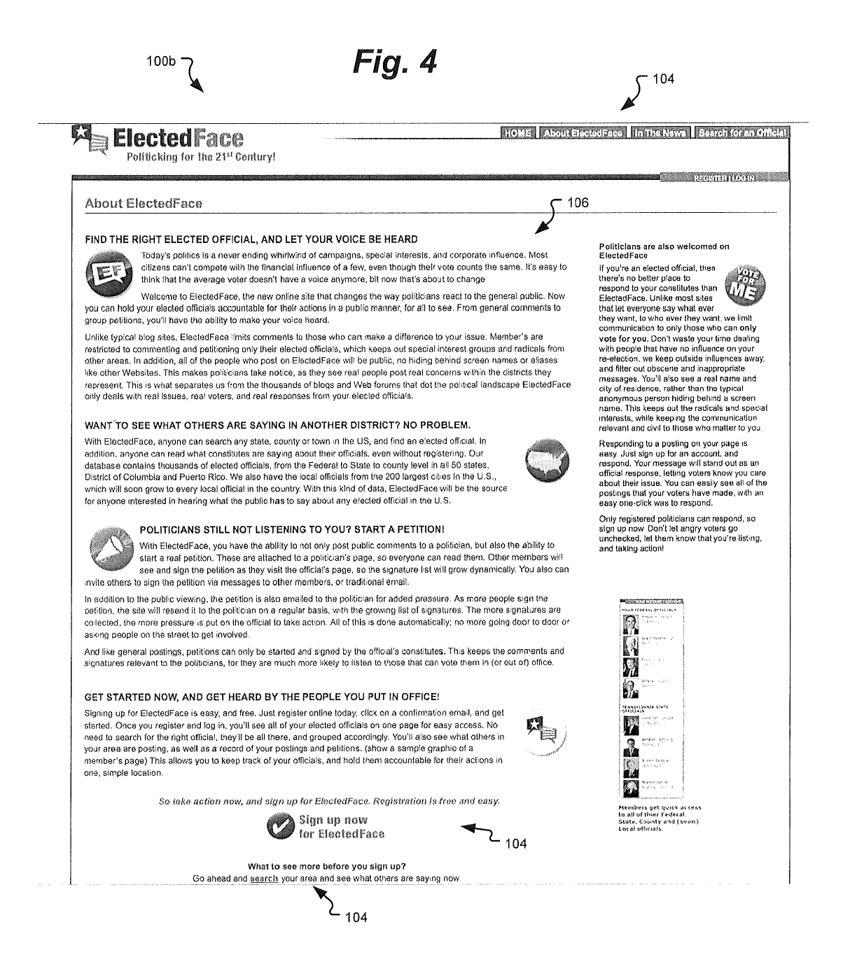

Referring now to FIG. 4, there is shown an embodiment of a page 100b of website 100. Page 100b may be well-suited for being presented when a user selects or otherwise activates a website navigation element corresponding to information about website 100 and/or its provider or services provided thereat or there-through. Page 100b may generally include navigation and/or content elements. In the illustrated embodiment of FIG. 4, navigation elements 104 allow users to: navigate to a homepage (e.g., to 100a); navigate to a page about the website (e.g., to 100b); read press about the website, such as by navigating to another page; search for elected officials and/or candidates, sign up to become a registered member; and log in as a registered member.

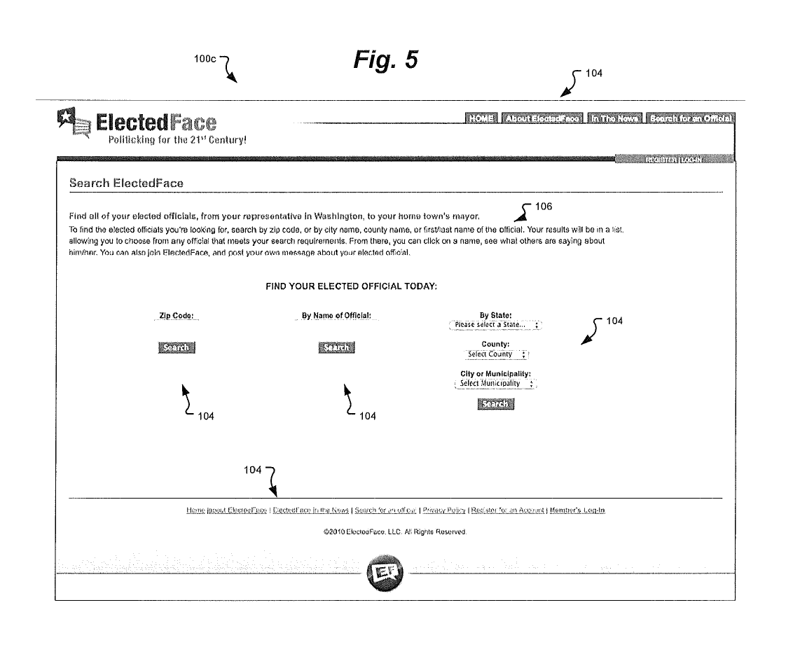

Referring now also to FIG. 5, there is shown an embodiment of a page 100c of website 100. Page 100c may be well-suited for being presented when a user selects or otherwise activates a website navigation element corresponding to searching for an elected official and/or candidate. Page 100c may generally include navigation and/or content elements. In the illustrated embodiment of FIG. 4, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member; log in as a registered member; enter a zip code corresponding to an elected official and/or candidate to be searched; enter a name corresponding to an elected official and/or candidate to be searched; search by state, county and/or city or municipality.

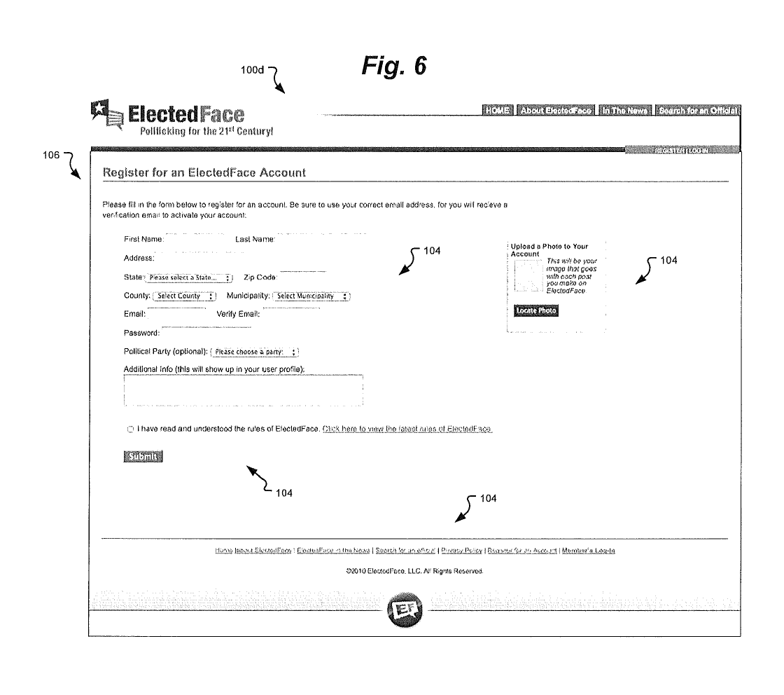

Referring now also to FIG. 6, there is shown an embodiment of a page 100d of website 100. Page 100d may be well-suited for being presented when a user selects or otherwise activates a website navigation element corresponding to signing up as a registered user. Page 100d may generally include navigation and/or content elements. In the illustrated embodiment of FIG. 6, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); and log in as a registered member, such as by navigating to a corresponding page; enter information to become a registered user (e.g., name, address, state, zip code, county, municipality, email address, password, political party, user name, and/or additional information such as an image, for example; and an acknowledgement as to having read applicable terms and/or conditions of use, as well as an element, in the case of FIG. 6 a button, to submit the information. Where no user name is provided for, such as in the illustrated case of FIG. 6, a unique or substantially unique registered user number may be assigned to each registered user, by way of further non-limiting example only.

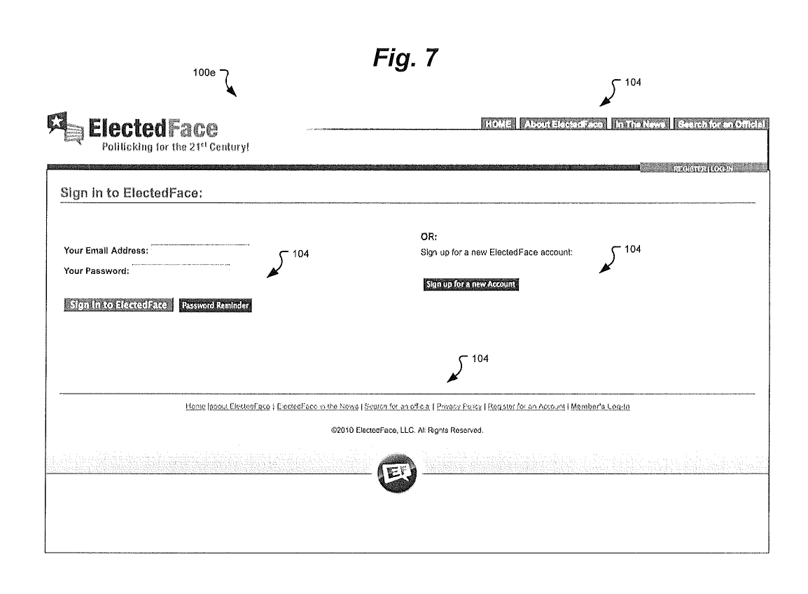

Referring now also to FIG. 7, there is shown an embodiment of a page 100e of website 100. Page 100e may be well-suited for being presented when a user selects or otherwise activates a website navigation element corresponding to logging in as a registered user. Page 100e may generally include navigation and/or content elements. In the illustrated embodiment of FIG. 7, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d ; and log in as a registered member (e.g., 100e); enter at least some of the information previously submitted to become a registered user (e.g., email address and password; and as an element, in the case of FIG. 7 a button, to submit the information.

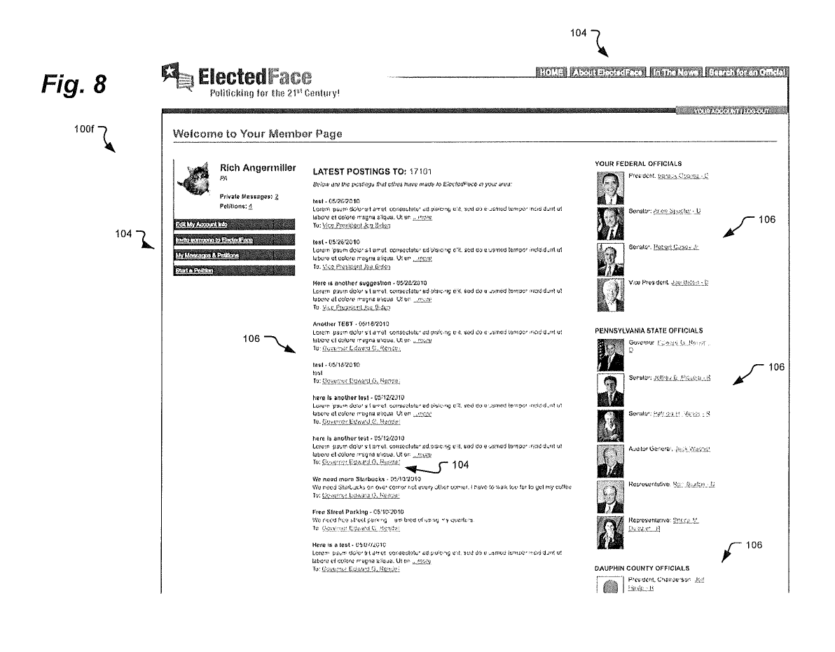

Referring now also to FIG. 8, there is shown an embodiment of a page 100f of website 100. Page 100f may be well-suited for being presented when a user has successfully signed in as a registered user and/or has entered criteria that can be used select various posts for presentation, for example (e.g., using 100e or 100c). Page 100f may generally include navigation and/or content elements. In the illustrated embodiment of FIG. 8, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); log in as a registered member (e.g., 100e); change account information associated with them (akin to that entered using 100d, for example; invite someone to the website 100 (such as by enabling them to send an email to such a person, for example); view messages and/or posts relevant to them (e.g., 100f), and start a petition.

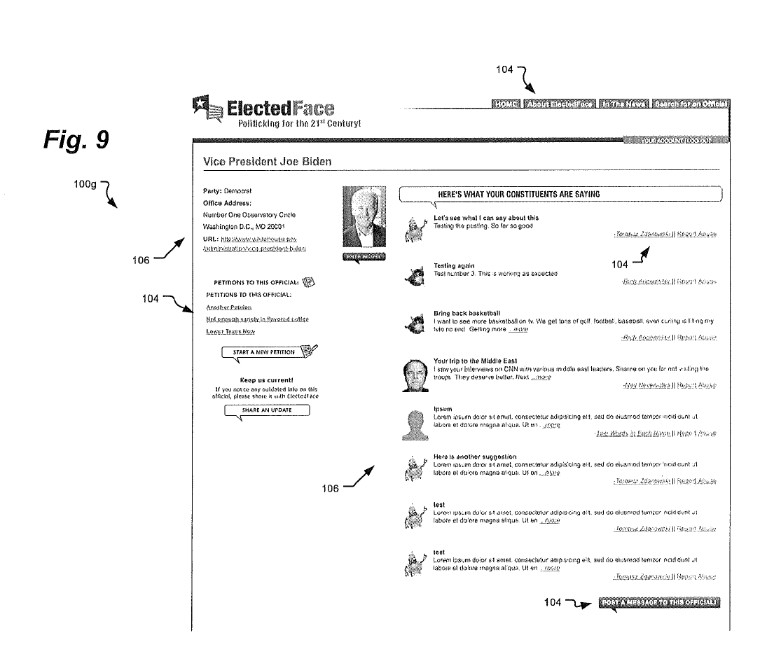

Referring now also to FIG. 9, there is shown an embodiment of a page 100g of website 100. Page 100g may be well-suited for being presented when a user has selected an official or candidate, for example (e.g., using 100f). Page 100g may generally include navigation and/or content elements. In the illustrated embodiment of FIG. 9, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); and log in as a registered member (e.g., 100e); change account information associated with them (akin to that entered using 100d, for example; invite someone to the website 100 (such as by enabling them to send an email to such a person, for example); start a petition, select a petition to virtually sign or otherwise endorse and post a message.

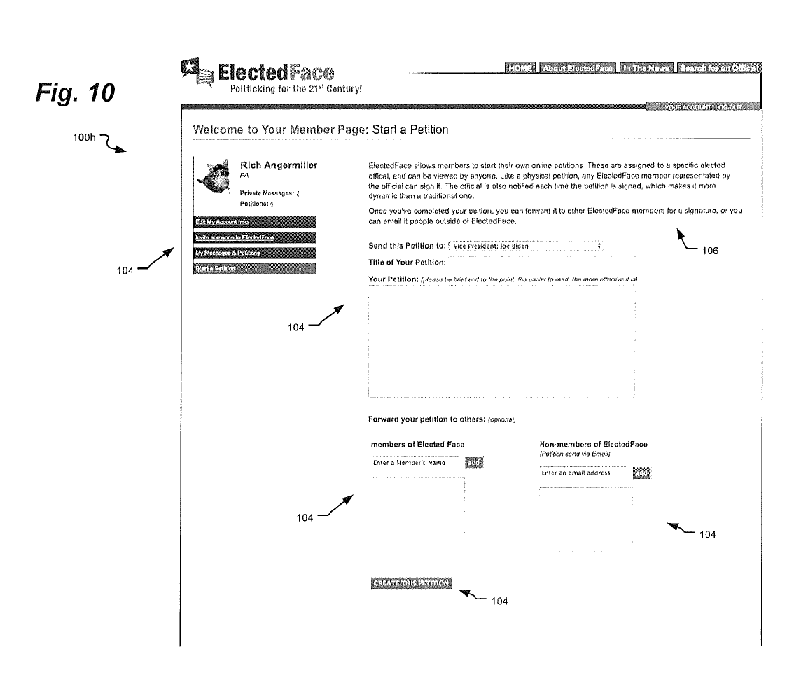

Referring now also to FIG. 10, there is shown an embodiment of a page 100h of website 100. Page 100h may be well-suited for being presented when a user has selected to start a petition (e.g., such as via page 100f or 100g). Page 100h may generally include navigation and/or content elements. In the illustrated embodiment of FIG. 10, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); and log in as a registered member (e.g., 100e); change account information associated with them (akin to that entered using 100d, for example); invite someone to the website 100 (such as by enabling them to send an email to such a person, for example); see messages or posts that relate to them and/or their elected officials and/or candidates; start a petition (e.g., 100h); select an official or candidate to send a petition to; name the petition; describe the petition; enter other persons to send the petition to (such as via email or intra-system messaging) and create the petition, such as by storing it in a database in accordance with the information provided.

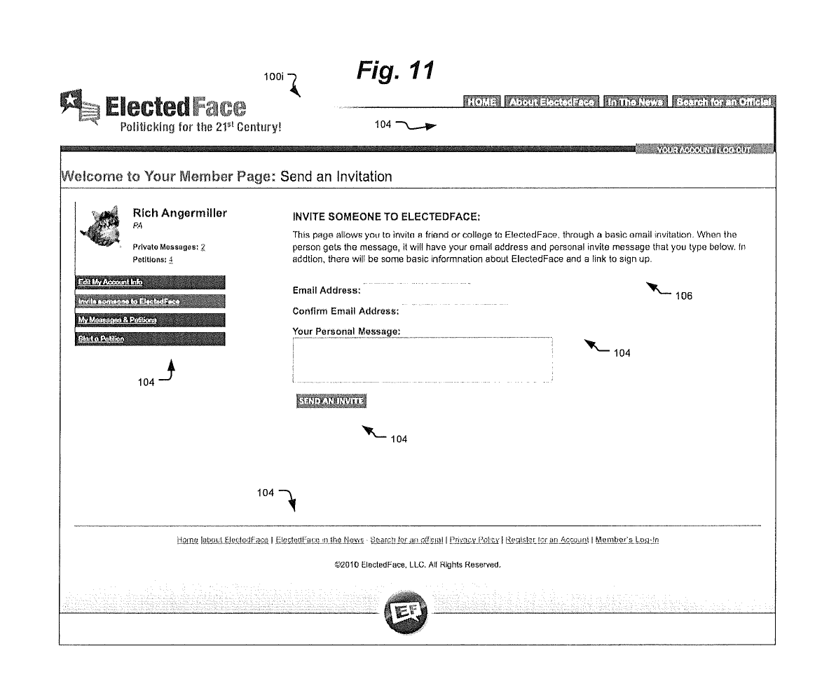

Referring now also to FIG. 11, there is shown an embodiment of a page 100i of website 100. Page 100i may be well-suited for being presented when a user has selected to send an invitation to someone else (e.g., such as via page 100h). Page 100i may generally include navigation and/or content elements. In the illustrated embodiment of FIG. 11, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); log in as a registered member (e.g., 100e); change account information associated with them (akin to that entered using 100d, for example); invite someone to the website 100 (such as by enabling them to send an email to such a person, for example); see messages or posts that relate to them and/or their elected officials and/or candidates; start a petition (e.g., 100h); enter an e-mail address corresponding to the intended invitee, enter a message for the intended invitee and send the invitation, thereby causing an automated e-mail message to be generated in accordance with the entered information.

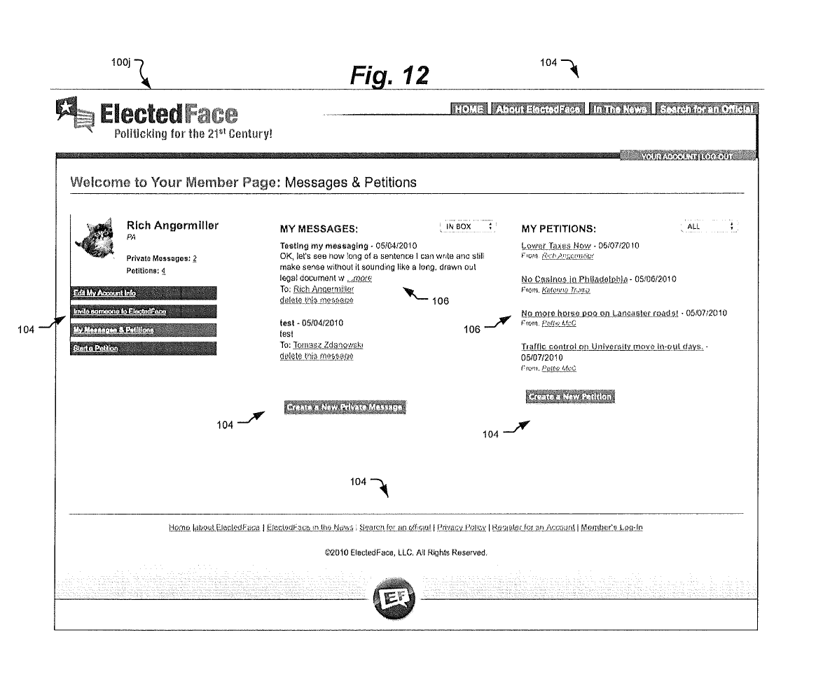

Referring now also to FIG. 12, there is shown an embodiment of a page 100j of website 100. Page 100j may be well-suited for being presented when a user has selected to see their messages (e.g., such as via page 100i). Page 100j may generally include navigation and/or content elements. In the illustrated embodiment of FIG. 12, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); log in as a registered member (e.g., 100e); change account information associated with them (akin to that entered using 100d, for example); invite someone to the website 100 (e.g., 100i); see messages or posts that relate to them and/or their elected officials and/or candidates (e.g., 100j); start a petition (e.g., 100h); change between message subsets (e.g., akin to folders, like an inbox, outbox, sent . . . ); change between petition subsets (e.g., akin to folders, like an all, new, old . . . ); and create new massages and/or petitions.

By way of further, non-limiting example only, users of computing devices 10, 30 may access devices 20 in a conventional manner, such as by using a conventional Internet connection and request website 100 via a conventional browser software functionality. Responsive thereto, page 100a may be provided and displayed to such requestors.

Upon seeing page 100a, such a visitor may elect to search for their elected officials and/or candidates by populating the illustrated “enter your zip code now” box, choosing a city using the “choose your city” drop-box and activating the “search now” button. In such an event, a page akin to 100c may be launched.

Upon seeing page 100a, such a visitor may alternatively, or additionally, opt to select or otherwise activate a go button associated with a “learn more about [the website]” option (such that a page akin to 100b is launched) and/or a “read what others are posting!” button (such that a page akin to 100f, 100g is launched).

In the illustrated embodiment, a user may opt to sign in, using the “member sign-in” textboxes and “go” button, such that a page akin to 100e is presented, and/or sign-up to become a registered member using the “register” link, such that a page akin to 100d is presented. Once logged in, a page akin to 100f may be presented.

Still by way of non-limiting example, a user may then use the interface of page 100f to select one of their officials, e.g., a federal, state, county or municipal official or candidate, for example. In such an event, a corresponding page 100g for the selected official or candidate may be displayed.

Using such a page 100g, a user may see information about the official or candidate, such as party affiliation, office address and website. A user may also be presented with petitions that have been created by users and that relate to that official. A user may also see posts to and/or about that official or candidate. Additionally, a user may opt to post a message to or about the official or candidate using a “post a message to this official” button. In such an event, page 100g may be modified, and/or another page presented in a conventional manner (e.g., akin to the petitions page 100h), to allow the user to create a new post that will then appear in the posts to and/or about that official or candidate displayed on the official's page 100g.

By way of further non-limiting example, a user viewing page 100a, may click a navigation element to “surf” to page 100b, to learn about the website and/or its operator. A user viewing page 100a, may click a navigation element to “surf” to page 100c, to find an elected official and/or candidate for election. A user viewing page 100a, may click a navigation element to “surf” to a page that lists stories and/or press releases regarding the website and/or its operator.

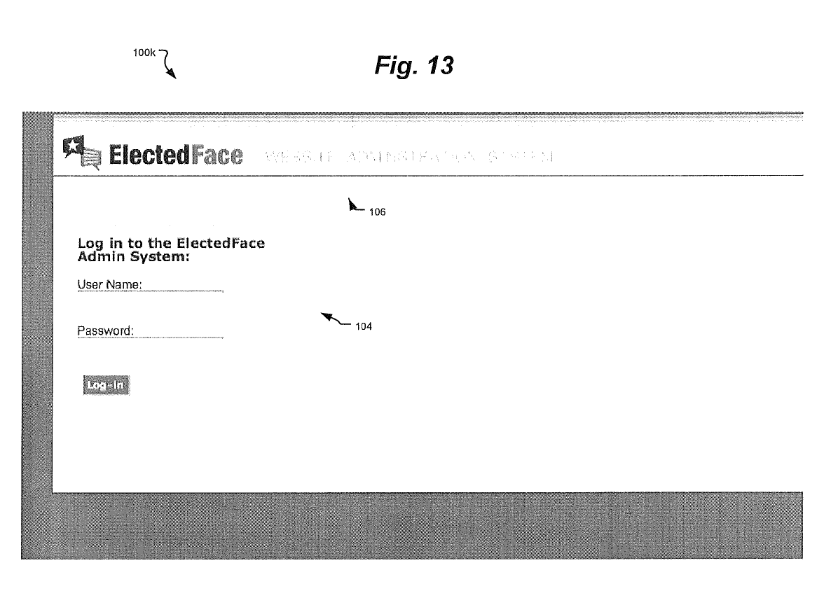

Referring now also to FIG. 13, there is shown an embodiment of a page 100k corresponding to website 100. Page 100k may be part of website 100 or a website associated with website 100. Page 100k may be well-suited for being presented when an administrative user of website 100 desires to log in to administrate website 100. Page 100k may generally include navigation and/or content elements. In the illustrated embodiment of FIG. 13, navigation elements 104 allow users to log into an administrative portal corresponding to website 100 in a conventional manner.

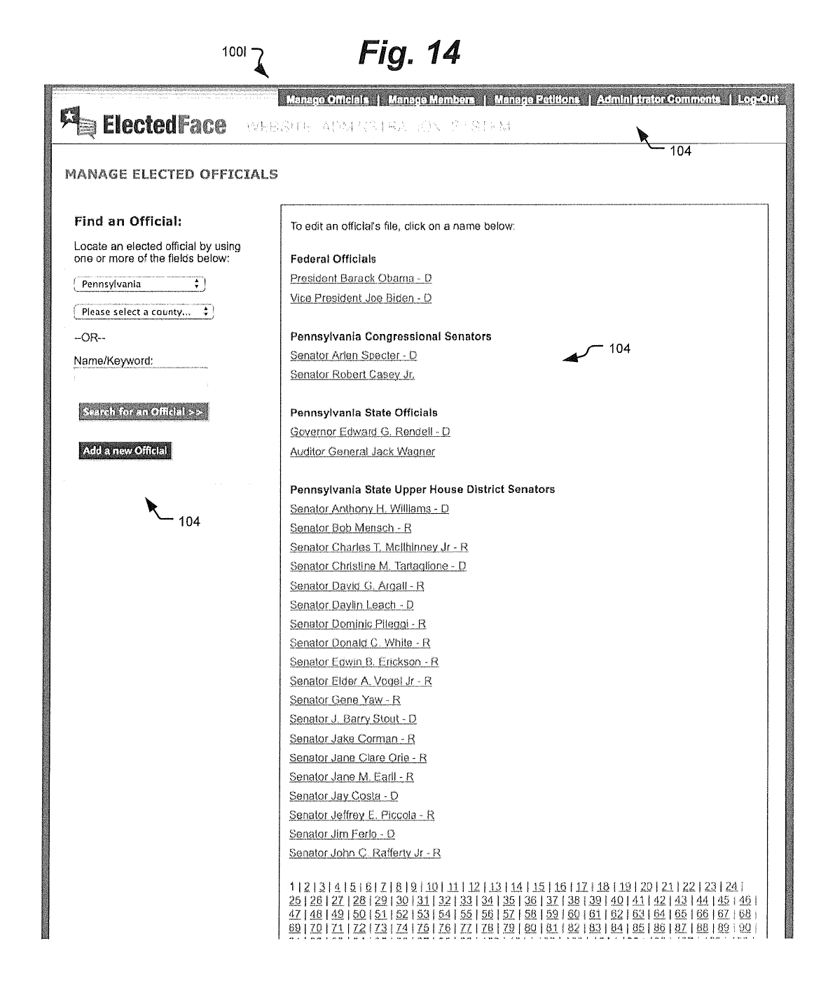

Referring now also to FIG. 14, there is shown an embodiment of a page 100l corresponding to website 100. Page 100l may be part of website 100 or a website associated with website 100. Page 100l may be well-suited for being presented when an administrative user of website 100 logs in to administrate website 100 (e.g., using 100k). Page 100l may generally include navigation and/or content elements. In the illustrated embodiment of FIG. 14, navigation elements 104 allow users to manage officials and/or candidates of website 100, manage members of website 100, manage petitions of website 100, provide comments, and log out. Page 100l additionally allows for a user to search for officials/candidates and add new officials/candidates.

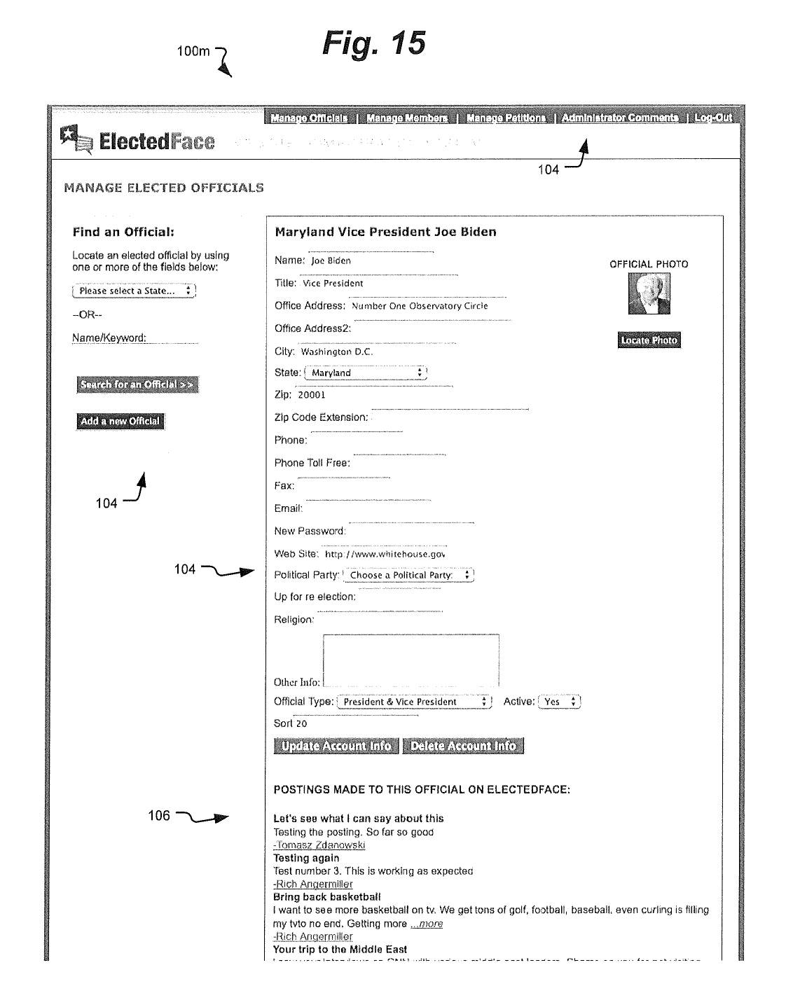

Referring now also to FIG. 15, there is shown an embodiment of a page 100m corresponding to website 100. Page 100m may be part of website 100 or a website associated with website 100. Page 100m may be well-suited for being presented when an administrative user of website 100 selects a candidate/official to check, change or delete information about (e.g., using 100l). Page 100m may generally include navigation and/or content elements. In the illustrated embodiment of FIG. 15, navigation elements 104 allow users to manage officials and/or candidates of website 100, manage members of website 100, manage petitions of website 100, provide comments, and log out. Page 100m additionally allows for a user to search for officials/candidates and add new officials/candidates. Additionally, page 100m allows a user to enter information to be presented (e.g., as elements 106) regarding officials, such as name, title, address, phone, fax, email, website, political party, religion, and/or other types of information. Additionally, page 100m allows a user to change such a politician's password, to log into the system.

Entered information may be stored in one or more databases included in or accessible to devices 20 (FIG. 1), for use in populating website 100 in a conventional manner.

In the illustrated case of FIG. 15, recent comments of other users regarding the subject politician are also shown. Posts, when entered, may similarly be stored in one or more databases included in or accessible to devices 20 (FIG. 1), for use in populating website 100 in a conventional manner.

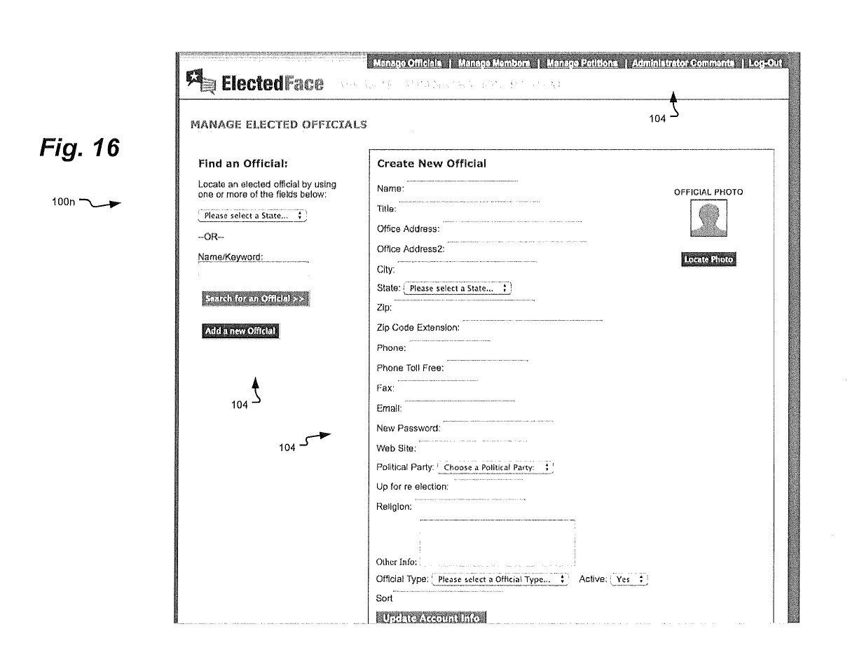

Referring now also to FIG. 16, there is shown an embodiment of a page 100n corresponding to website 100. Page 100n may be part of website 100 or a website associated with website 100. Page 100m may be well-suited for being presented when an administrative user of website 100 selects a candidate/official to add information about (e.g., using 100l). Page 100n may generally include navigation and/or content elements. In the illustrated embodiment of FIG. 16, navigation elements 104 allow users to manage officials and/or candidates of website 100, manage members of website 100, manage petitions of website 100, provide comments, and log out. Page 100n additionally allows for a user to search for officials/candidates and add new officials/candidates. Additionally, page 100n allows a user to enter information to be presented (e.g., as elements 106) regarding officials, such as name, title, address, phone, fax, email, website, political party, religion, and/or other types of information. Additionally, page 100m allows a user to change such a politician's password, to log into the system.

Entered information may be stored in one or more databases included in or accessible to devices 20 (FIG. 1), for use in populating website 100 in a conventional manner.

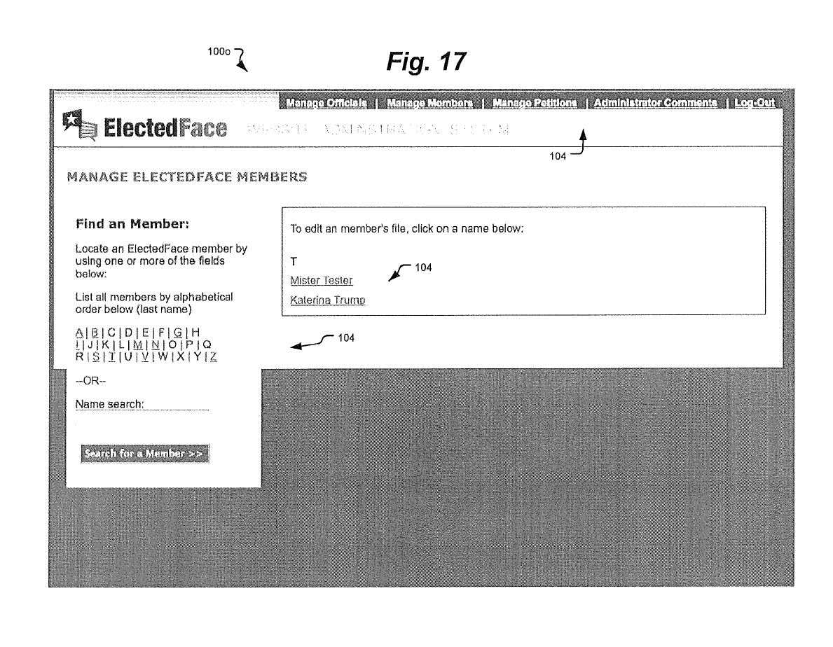

Referring now also to FIG. 17, there is shown an embodiment of a page 100o corresponding to website 100. Page 100o may be part of website 100 or a website associated with website 100. Page 100o may be well-suited for being presented when an administrative user of website 100 desires to find a registered user (e.g., using 100l). Page 100o may generally include navigation and/or content elements. In the illustrated embodiment of FIG. 17, navigation elements 104 allow users to manage officials and/or candidates of website 100, manage members of website 100, manage petitions of website 100, provide comments, and log out. Page 100o additionally allows for a user to search for registered members in an analogous method to those presented above. For example, registered members may be listed in a predefined order, such as alphabetically, and/or be searchable.

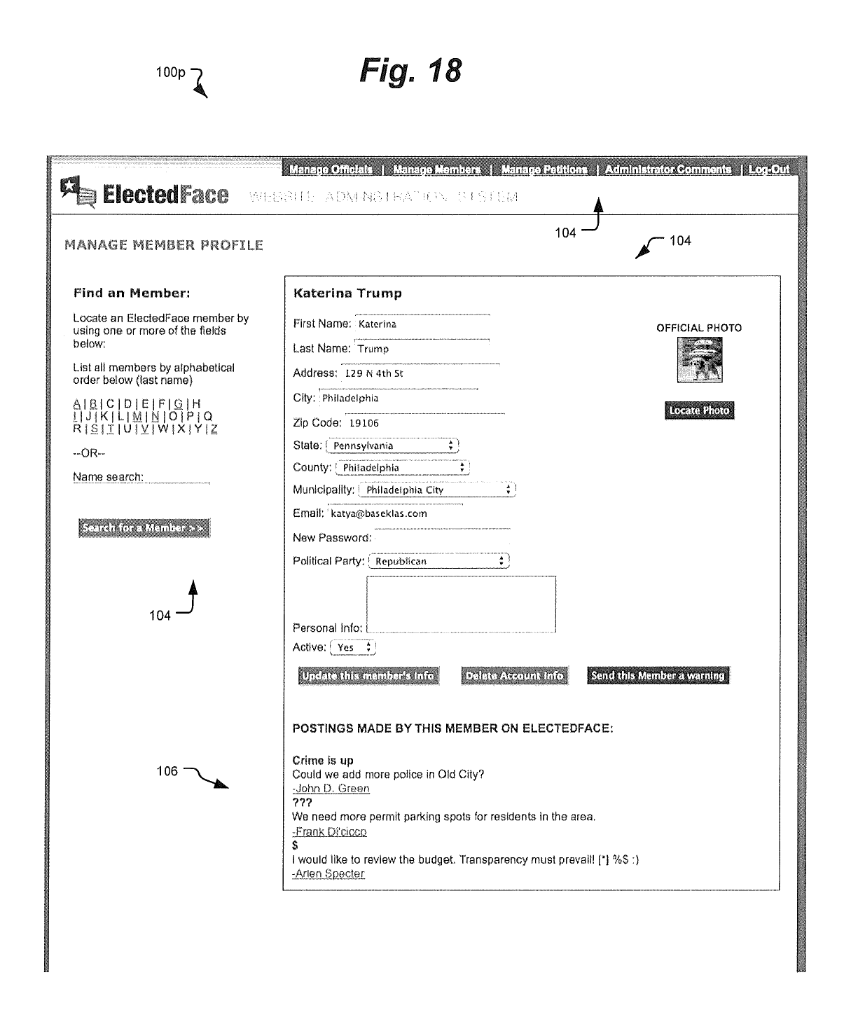

Referring now also to FIG. 18, there is shown an embodiment of a page 100p corresponding to website 100. Page 100p may be part of website 100 or a website associated with website 100. Page 100p may be well-suited for being presented when an administrative user of website 100 selects a registered member to change information about (e.g., using 100o). Page 100p may generally include navigation and/or content elements. In the illustrated embodiment of FIG. 18, navigation elements 104 allow users to search for and manage registered users of website 100, by for example, allowing administrative users to enter and/or change name, address, email, password, political party affiliation and/or other information regarding registered users.

Page 100p also includes button for allowing a user to be deleted from the site, e.g., unregistered by deleting them from the registered users database, and/or flagging one or more subject accounts as inactive. Page 100p also includes a button for allowing a user to be sent an email warning them regarding the use of the site.

Entered information may be stored in one or more databases included in or accessible to devices 20 (FIG. 1), for use in populating website 100 in a conventional manner.

In the illustrated case of FIG. 18, recent comments or posts of a subject user are also shown.

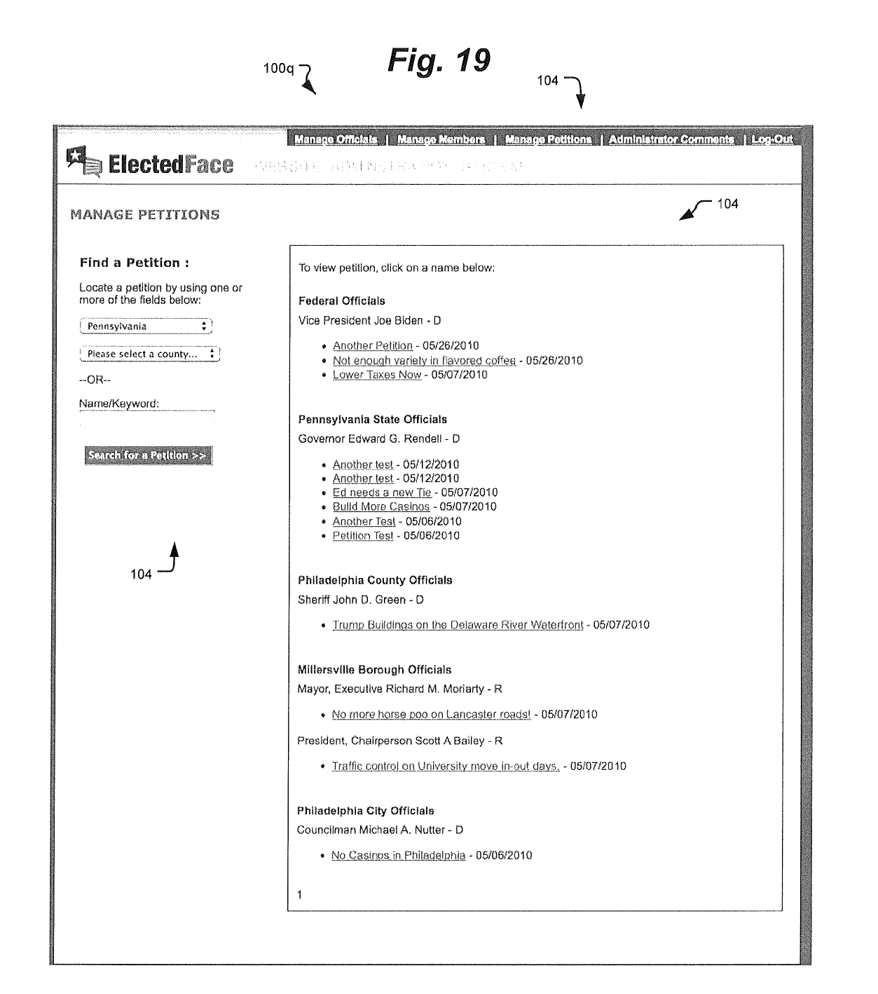

Referring now also to FIG. 19, there is shown an embodiment of a page 100q corresponding to website 100. Page 100q may be part of website 100 or a website associated with website 100. In the illustrated embodiment of FIG. 19, navigation elements 104 allow users to manage officials and/or candidates of website 100, manage members of website 100, manage petitions of website 100, provide comments, and log out. Page 100q additionally allows for a user to search for officials/candidates and add new officials/candidates. Additionally, page 100q allows a user to search for and find petitions regarding politicians and political areas, such as nation, state, county and municipality.

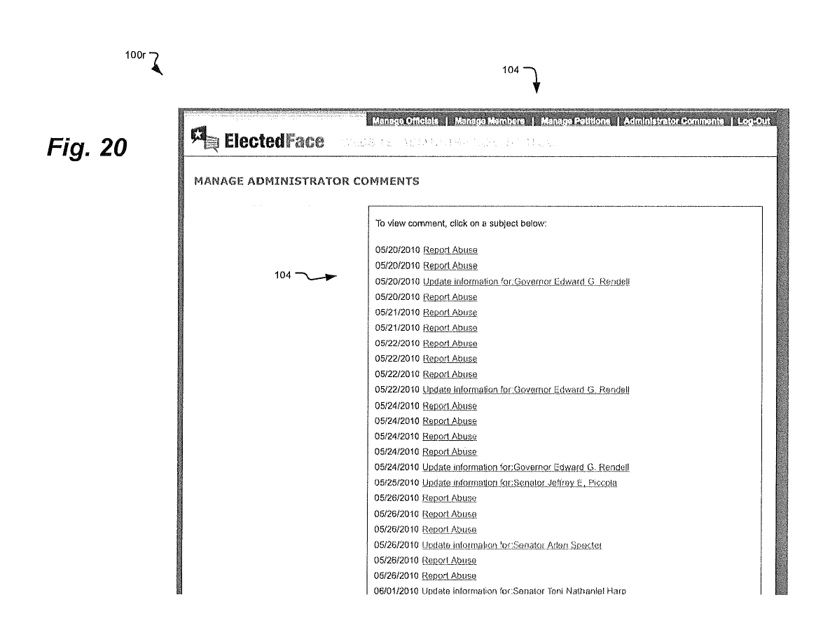

Referring now also to FIG. 20, there is shown an embodiment of a page 100r corresponding to website 100. Page 100r may be part of website 100 or a website associated with website 100. In the illustrated embodiment of FIG. 20, navigation elements 104 allow users to manage officials and/or candidates of website 100, manage members of website 100, manage petitions of website 100, provide comments, and log out. Page 100r additionally allows for an administrative user to manage communications, such as abuse reports, associated with website 100.

By way of non-limiting further explanation, if a user of website 100 believes the system is being abused, such as via what he/she deems to be inappropriate posts or petitions, they may opt to report system abuse, such as by activating a “Report Abuse” link (e.g., 100g). An entry in a database part of or accessible to devices 20 may be generated responsively to such a link activation.

Upon requesting page 100r, such as by activating an “Administrative Comments” link (e.g., 100l), such a database may be used to populate page 100r. An administrative user may use the administrative pages discussed herein to investigate and take appropriate action regarding such reports, such as ignoring the report, deleting a post and/or warning or deleting a registered user. Other changes to the system databases may also be logged, for example.

It will be apparent to those skilled in the art that modifications and variations may be made in the systems and methods of the present invention without departing from the spirit or scope of the invention. It is intended that the present invention cover the modifications and variations of this invention provided they come within the scope of the appended claims and their equivalents.

1. A method comprising:
storing, at a server operatively connected to a communication network, information associated with at least one elected official and/or at least one candidate for election, wherein the information defines a constituency group for each elected official and for each candidate for election for which information is stored on the server;
qualifying a user for one or more of the constituency groups when the user accesses the server through a computing device; and
providing the user access to the information associated with those elected officials and candidates for election for which the user is a qualified member of the respective constituency group.
